(19) United States
(12) Patent Application Publication
(10) Pub. No.: US 2017/0202074 A1
(43) Pub. Date: Jul. 13, 2017

(54) OUTDOOR ILLUMINATION SYSTEM AND ENERGY-SAVING CONTROL BOX THEREOF

(71) Applicant: DONGGUAN YINGHUI LIGHTING CO., LTD., Dongguan (CN)

(72) Inventor: Shuisheng XU, Dongguan (CN)

(21) Appl. No.: 15/393,472

(22) Filed: Dec. 29, 2016

(30) Foreign Application Priority Data
Jan. 7, 2016 (CN) 201620016589.9

(51) Int. Cl. H05B 37/02

(52) U.S. Cl. CPC H05B 37/0218; H05B 37/0281; H05B 37/0227; H05B 37/0272

(57) ABSTRACT

An outdoor illumination system comprises an energy-saving control box, an external power supply, an illumination lamp and a PIR detection device. The energy-saving control box comprises a power input end, a power output end, a relay switch for connecting the power input end and the power output end, and a control module electrically connected to the relay switch. The control module comprises a photosensitive switch, a timer and a wireless receiver. The photosensitive switch is configured to sense the external illumination intensity. The wireless receiver is configured to receive detecting information from the PIR detection device. The control module is configured to control the relay switch according to the sensing information of the photosensitive switch and the information received by the wireless receiver. The timer is configured to control a lighting duration.

### FIELD OF THE INVENTION

The present patent relates to a device for controlling a lamp smartly, in particular to an energy-saving control box and an outdoor illumination lamp applying the same.

### BACKGROUND OF THE INVENTION

As a landscape lamp, a pin lamp which is a lamp indispensable in outdoor decoration and is widely applied to places, such as a park, a square, a district, a street and a courtyard can produce an appropriate effect of roadway illumination on the one hand, and can also produce a decoration effect on the other hand. The existing pin lamp is directly connected to a power supply without a smart on/off function. Typically a floor lamp is at an on state all night with poor flexibility and is thus likely to cause waste of electric energy.

### SUMMARY OF THE INVENTION

On this basis, it is necessary to provide an outdoor illumination system having electricity conservation and energy saving functions and an energy-saving control box thereof, with respect to the defects in the prior art. An energy-saving control box is used in cooperation with an external illumination lamp and configured to control the illumination lamp smartly. The energy-saving control box comprises a power input end, a power output end, a relay switch for connecting the power input end and the power output end, and a control module electrically connected to the relay switch, wherein the control module comprises a photosensitive switch, a timer and a wireless receiver. The photosensitive switch is configured to sense the external illumination intensity. The wireless receiver is configured to receive external detecting information. The control module is configured to control the relay switch according to the sensing information of the photosensitive switch and the information received by the wireless receiver. The timer is configured to control a lighting duration and cut off a relay. When the photosensitive switch senses that the external illumination intensity is insufficient and the wireless receiver receives information on a moving object, the control module controls the relay switch to be closed, and a circuit is turned on. When the lighting duration reaches a set value, the timer sends a signal to cut off the relay switch, and the illumination lamp stops working.

Further, the power input end and the power output end are connector interfaces.

An outdoor illumination system comprises an energy-saving control box, an external power supply, an illumination lamp and a PIR detection device. The external power supply, the energy-saving control box and the illumination lamp are sequentially connected in series. The PIR detection device is arranged outside and configured to perform infrared detection. The energy-saving control box comprises a power input end, a power output end, a relay switch for connecting the power input end and the power output end, and a control module electrically connected to the relay switch. The control module comprises a photosensitive switch, a timer and a wireless receiver. The photosensitive switch is configured to sense the external illumination intensity. The wireless receiver is configured to receive detecting information from the PIR detection device. The control module is configured to control the relay switch according to the sensing information of the photosensitive switch and the information received by the wireless receiver. When the photosensitive switch senses that the external illumination intensity is insufficient and the wireless receiver receives information on a moving object, the relay switch is closed, and the illumination lamp starts to work. The timer is configured to control a lighting duration. When the lighting duration reaches a set value, the timer sends a signal to cut off the relay switch, and the illumination lamp stops working.

Further, the outdoor illumination lamp further comprises a transformer which is connected to the external power supply in series and configured to adjust an output voltage of the external power supply.

Further, the external power supply, the transformer, the energy-saving control box and the illumination lamp are sequentially connected in series, and the energy-saving control box is connected in series between the transformer and the illumination lamp.

Further, the external power supply, the energy-saving control box, the transformer and the illumination lamp are sequentially connected in series, and the energy-saving control box is connected in series between the external power supply and the transformer.

Further, the illumination lamp consists of a plurality of pin lamps.

The present patent has the beneficial effects: an external lamp is controlled smartly by arranging an independent energy-saving control box, such that the electricity consumption is reduced, energy conservation and environmental protection are achieved, and integral disassembly and assembly are convenient for ease of maintenance. In addition, the outdoor illumination system consisting of the energy-saving control box, the external power supply, the transformer, the illumination lamp and the PIR detection device not only has the functions of electricity conservation and energy saving, but also is anti-theft to achieve a safety protection effect at night.

### BRIEF DESCRIPTION OF THE DRAWINGS

FIG. 1 is a connection schematic diagram of various components in an energy-saving control box of the present patent;

FIG. 2 is a connection schematic diagram of an outdoor illumination system of the present patent;

FIG. 3 is a state diagram when the outdoor illumination system is in use; and

FIG. 4 is a connection schematic diagram of another embodiment of the outdoor illumination system as shown in FIG. 2.

### DETAILED DESCRIPTION OF THE PREFERRED EMBODIMENTS

The present patent will be further described in detail as below in conjunction with the drawings and the embodiments, in order to make the objective, the technical solution and the advantages of the present patent be understood more clearly.

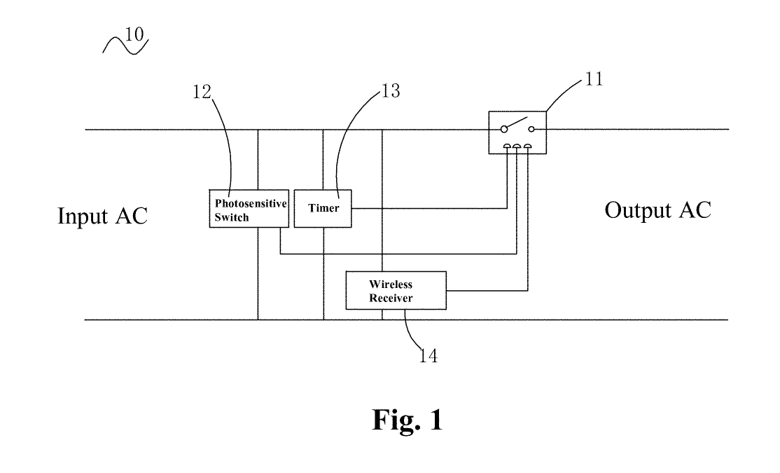

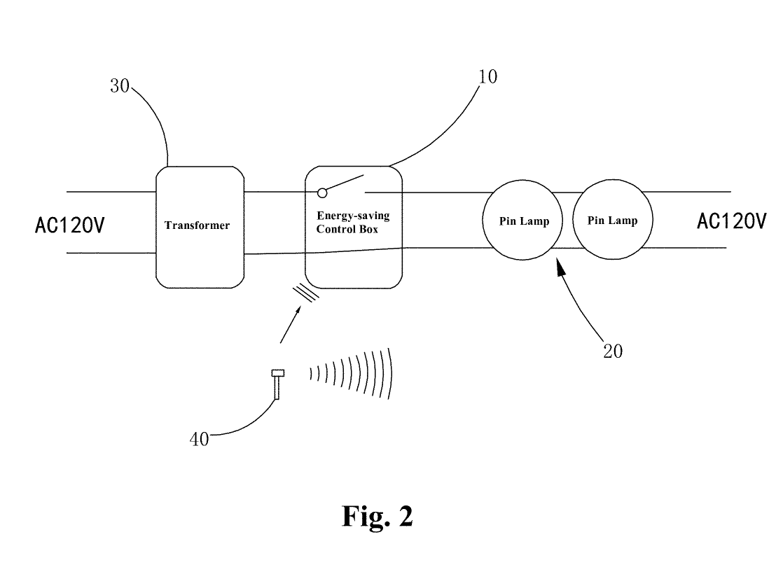

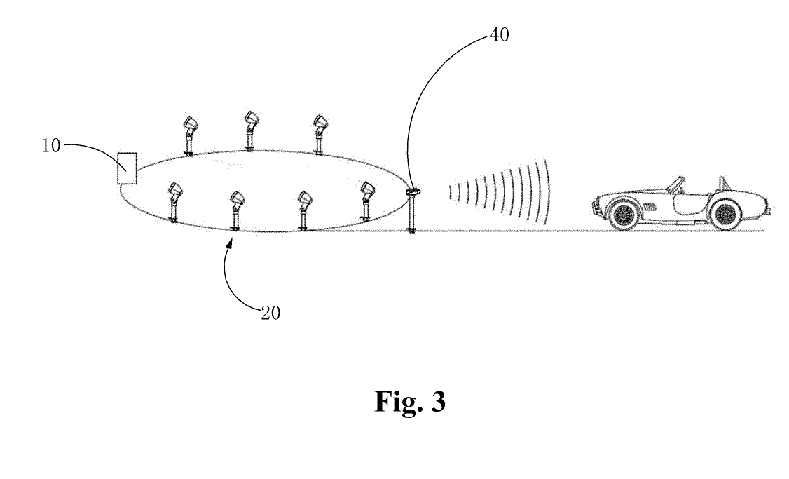

Referring to FIG. 1 to FIG. 3, the present patent provides an energy-saving control box 10 which is used in cooperation with an external illumination lamp 20 and configured to control the illumination lamp 20 smartly. As an independent control module, the energy-saving control box 10 can be freely disassembled and assembled from the whole illumination system and is convenient to maintain and change with good flexibility.

The energy-saving control box 10 comprises a power input end, a power output end, a relay switch 11 for connecting the power input end and the power outlet end, and a control module electrically connected to the relay switch 11. For convenience in disassembly and assembly, the power input end and the power output end are made into a form of connector interfaces and are directly connected in cooperation with ports of the external power supply directly. The control module comprises a photosensitive switch 12, a timer 13 and a wireless receiver 14. The photosensitive switch 12 is configured to sense the external illumination intensity. The wireless receiver 14 is configured to receive external information. When the photosensitive switch 12 senses that the external illumination intensity is insufficient and the wireless receiver 14 receives information on a moving object, the control module sends a signal to enable the relay switch 11 to be closed, and a circuit is turned on, the external illumination lamp 20 starts to work, and the timer 13 controls a closing duration (namely the lighting duration) of the relay switch 11.

When in use, the energy-saving control box 10, the external power supply, the transformer 30 and the PIR detection device constitute an outdoor illumination system. The external power supply, the transformer 30, the energy-saving control box 10 and the illumination lamp are sequentially connected in series. The PIR detection device is arranged outside and configured to perform infrared detection. When detecting that a person or an animal enters a detected range, the PIR detection device will send a signal to the wireless receiver 14 of the energy-saving control box 10. If the photosensitive switch 12 senses that the external illumination intensity is insufficient, the relay switch 11 will be closed, the circuit is turned on, and the illumination lamp 20 starts to work to perform illumination; meanwhile, the timer 13 starts to work to control the lighting duration. When a count in the timer 13 reaches a design value, the timer 13 sends a signal, the control module controls the relay switch 11 to be cut off, and the illumination lamp 20 stops illuminating to save electric energy.

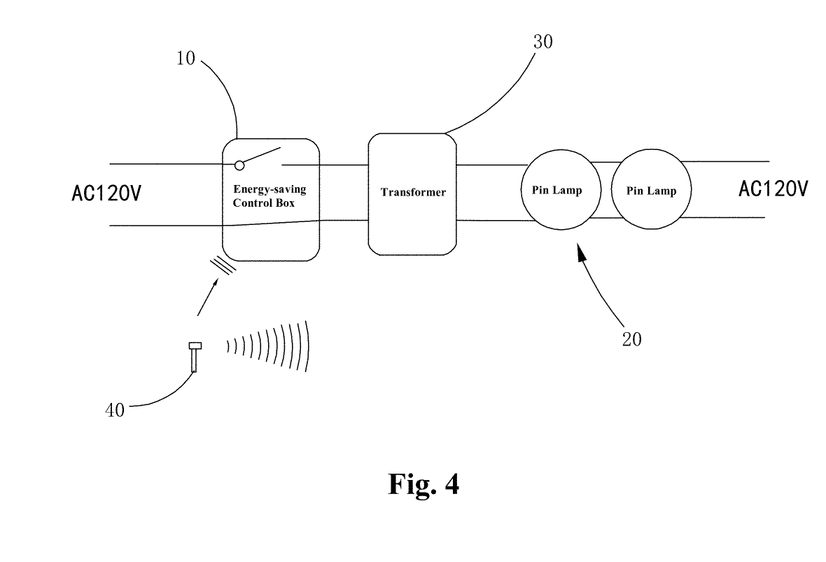

It can be understood that, in this embodiment, the external power supply, the transformer 30, the energy-saving control box 10 and the illumination lamp 20 are sequentially connected in series, the energy-saving control box 10 is connected in series between the transformer 30 and the illumination lamp 20, and the illumination lamp 20 consists of a plurality of pin lamps. In other embodiments, the energy-saving control box 10 may also be connected in series between the external power supply and the transformer 30 (referring to FIG. 4), and the illumination lamp 20 may also consist of other types of lamps, such as pendant lamps, wall lamps and ceiling lamps.

The present patent has the beneficial effects: an external lamp is controlled smartly by arranging an independent energy-saving control box 10, such that the electricity consumption is reduced, energy conservation and environmental protection are achieved, and integral disassembly and assembly are convenient for ease of maintenance. In addition, the outdoor illumination system consisting of the energy-saving control box 10, the external power supply, the transformer 30, the illumination lamp 20 and the PIR detection device not only has the functions of electricity conservation and energy saving, but also is anti-theft to achieve a safety protection effect at night.

The above embodiments only express one implementation of the present utility mode, and its description is more specific and detailed, but may not be interpreted to limit the patent scope of the present patent. It should be noted that, for those common skilled in the art, several deformations and improvements made without departing from the concept of the present patent will fall into the protection scope of the present patent. Therefore, the patent protection scope of the present patent should be subject to the attached claims.

What is claimed is:

1. An energy-saving control box for use with an external illumination lamp and configured to control the illumination lamp smartly, comprising a power input end, a power output end, a relay switch for connecting the power input end and the power output end, and a control module electrically connected to the relay switch, wherein the control module comprises a photosensitive switch, a timer and a wireless receiver; the photosensitive switch is configured to sense the external illumination intensity; the wireless receiver is configured to receive external detecting information; the control module is configured to control the relay switch according to the sensing information of the photosensitive switch and the information received by the wireless receiver; the timer is configured to control a lighting duration and cut off a relay.

2. The energy-saving control box according to claim 1, wherein the power input end and the power output end are connector interfaces.

3. An outdoor illumination system, comprising an energy-saving control box, an external power supply, an illumination lamp and a PIR detection device, wherein the external power supply, the energy-saving control box and the illumination lamp are sequentially connected in series; the PIR detection device is arranged outside and configured to perform infrared detection; the energy-saving control box comprises a power input end, a power output end, a relay switch for connecting the power input end and the power output end, and a control module electrically connected to the relay switch, wherein the control module comprises a photosensitive switch, a timer and a wireless receiver; the photosensitive switch is configured to sense the external illumination intensity; the wireless receiver is configured to receive detecting information from the PIR detection device; the control module is configured to control the relay switch according to the sensing information of the photosensitive switch and the information received by the wireless receiver; the timer is configured to control a lighting duration.

4. The outdoor illumination system according to claim 3, further comprising a transformer which is connected to the external power supply in series and configured to adjust an output voltage of the external power supply.

5. The outdoor illumination system according to claim 4, wherein the external power supply, the transformer, the energy-saving control box and the illumination lamp are sequentially connected in series, and the energy-saving control box is connected in series between the transformer and the illumination lamp.

6. The outdoor illumination system according to claim 4, wherein the external power supply, the energy-saving control box, the transformer and the illumination lamp are sequentially connected in series, and the energy-saving control box is connected in series between the external power supply and the transformer.

7. The outdoor illumination system according to claim 3, wherein the illumination lamp consists of a plurality of pin lamps.
